(19) United States
(12) Patent Application Publication
(10) Pub. No.: US 2009/0271337 A1
(43) Pub. Date: Oct. 29, 2009

(54) APPARATUS AND METHOD FOR INPUT AND OUTPUT TO PROCESS TO BE OPTIMIZED

(76) Inventors: Alkis VAZACOPOULOS, Harrington Park, NJ (US); Horia TIPI, New York, NY (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/274,245

(22) Filed: Nov. 19, 2008

Related U.S. Application Data
(60) Provisional application No. 61/048,162, filed on Apr. 25, 2008.

(51) Int. Cl. G06F 17/00; G06G 7/48

(52) U.S. Cl. 706/11; 703/6

(57) ABSTRACT

A computer system includes an optimization component for optimizing a solution to a problem using a computer and a display. The display includes a first user interface component adapted to elicit and receive information from a user. The computer system also includes a conversion component for converting the at least one of the plurality of constraints which has been selected to an input to the optimization component. The display also includes a second user interface component adapted to present performance information to a user. The performance information includes an optimized output from the optimization component which is based in part on the at least one constraint selected by the user.

### CROSS REFERENCE TO RELATED APPLICATIONS

The present application claims priority under 35 U.S.C. §119 to U.S. Provisional Application Ser. No. 61/048,162, filed Apr. 25, 2008, entitled “APPARATUS AND METHOD FOR INPUT AND OUTPUT TO PROCESS TO BE OPTIMIZED”, the disclosure of which is incorporated herein by reference.

### TECHNICAL FIELD

Various embodiments described herein relate to apparatus, systems, and methods associated with and optimizing apparatus and method for input and output to process.

### BACKGROUND INFORMATION

A typical method in the development of business models and software for dealing with various situations includes business users who define the optimization problem and refine business requirements. The business users are typically interviewed and the problem is sized and “thrown over the wall” to O.R. experts who implement the mathematical formulation for the optimization problem and to software developers who develop a front-end for the optimization problem. A difficulty with this process is that ultimately the interviewer must select a problem for optimization. The interviewer typically can not learn all the variables for a business problem in any interview since the business person operates in the problem environment most of his or her working hours. The solution to the problem is typically fed back to the business user who, many times, will make alterations or tweaks to see how these alterations or tweaks change the performance results. For each iteration of the problem, the interviewer must reformulate the optimization problem to incorporate the tweaks or alterations. Arriving at a satisfactory solution takes time since each iteration of the problem and the attendant reformulation of the optimization problem takes time.

The quality of the final result may suffer slightly since the business user may ultimately compromise early due to time constraints or budgetary constraints. The quality may suffer slightly due to the fact that the business user's input is filtered by an interviewer that does not understand or appreciate the intricacies or subtle aspects of the problem to be optimized.

Therefore, there is a need for a process and apparatus that allows a user, such as a business user, of a problem or procedure that needs optimization to provide more input and more feedback in a process that does not filter the input through another person.

### BRIEF DESCRIPTION OF THE DRAWINGS

FIG. 1 is a schematic diagram of a computer system, according to an example embodiment. FIG. 2 is a flow diagram of a method associated with the computer system, according to an example embodiment (22).

FIG. 3 is a screen shot of an active display associated with a display device of a computer system, according to an example embodiment.

FIG. 4 is a schematic diagram of a pricing engine, according to an example embodiment).

FIG. 5 is a flow diagram of a method associated with the computer system, according to an example embodiment.

FIG. 6 is a flow diagram of a method associated with the computer system, according to an example embodiment.

FIG. 7 shows a flow diagram of an optimization of a recommendation engine, according to an example embodiment.

### DETAILED DESCRIPTION

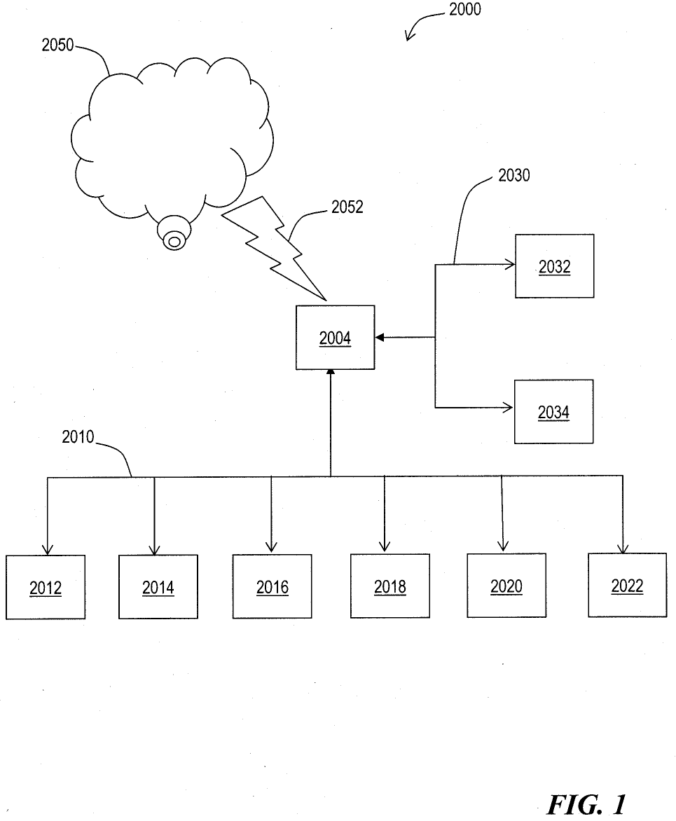

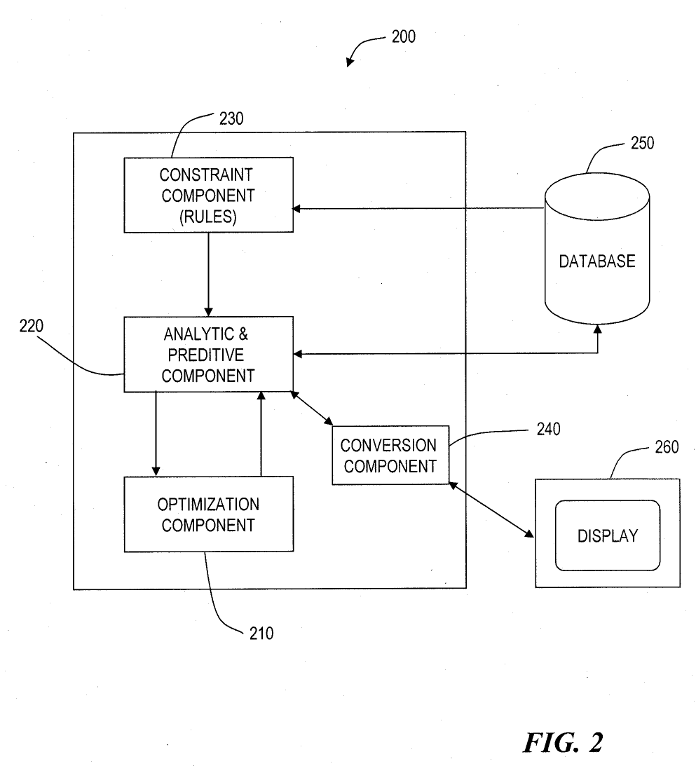

A block diagram of a computer system 2000, according to an example embodiment of this invention, is shown in FIG. 1. The computer system 2000 may also be called an electronic system or an information handling system and includes a central processing unit 2004, a memory and a system bus 2030. The information handling system includes a central processing unit 2004, a random access memory 2032, and a system bus 2030 for communicatively coupling the central processing unit 2004 and the random access memory 2032. The information handling system 2000 includes a disc drive device which includes the ramp described above. The information handling system 2002 may also include an input/output bus 2010 and several devices peripheral devices, such as 2012, 2014, 2016, 2018, 2020, and 2022 are attached to the input output bus 2010. Peripheral devices may include hard disc drives, magneto optical drives, floppy disc drives, monitors, keyboards and other such peripherals. One of the peripheral devices, such as 2022 includes a display. The display presents information to a user. The display 2022 may be configured to elicit information and commands from the user. The commands and information are converted to inputs and placed on the input output bus 2010 for transport to the processing unit 2004. The processing unit may also place outputs on the input output bus 2010 for presentation at the display device 2022.

In some embodiments, the computer system 2000 may operate in a networked environment using a communication connection to connect to one or more remote computers. As shown in FIG. 1, the computer system 2000 is communicatively coupled to a network 2050 through a link 2052. The link 2052 can be wired or wireless. The remote computer can be a single computer or a plurality of computers, such as a local area network, wide area network, or the internet. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2004 of the computer system 2000. Computer-readable instructions may be stored in the random access memory 2032 or in the read only memory 2034. In addition, computer readable instructions may be stored in peripheral devices, such as 2012, 2014, 2016, 2018, 2020 or 2022. A hard disk drive, CD-ROM, a tape drive or any similar storage device are some examples of a computer-readable medium that may be a peripheral attached to the input output bus 2010. In addition, a remote computer associated with the network 2050 may store a set of computer-readable instructions. These instructions can be sent to the processor 2004 over the link 2052 which communicatively couples the processor 2004 to the network 2050. Therefore, the machine-readable or computer-readable instruction set net not be resident on the computer 2000 but can also be transported over the network 2050 to the computer 2000.

FIG. 2 is another schematic diagram of a computing system 200 that includes a plurality of components formed by the computer system 2000 (shown in FIG. 1) and the machine-readable or computer-readable instructions, according to an embodiment of the invention. The computing system 200 includes an optimization component 210, a predictive and analytic component 220, a constraint component 230 and a conversion component 240. The predictive and analytic component 220 is communicatively coupled to a database 250. The database 250 includes data which is analyzed to form a model. Typically, the model is formed by analyzing historical data in the database 250. The database may be relatively small or may be relatively large. For example, the database 250, in one embodiment, may include terabytes of data on thousands of transactions used in a business. Analytics, associated with the analytic and predictive component 220, are used to analyze the data to find relationships and produce a model. Once the model is formed, the model can then be used to project forward in time and predict future events using the analytic and predictive component 220. The predictions are monitored to determine if and when these events occur. The monitoring function acts as a feedback loop which is used to further refine the initial model of the analytic and predictive component 220.

A user has the option of applying constraints via the constraint component 230. The constraint component 230 includes a number of rules and other constraints that the user can apply to the model. For example, the model may be for any number of entities in the database 250. If the user is associated with a lending institution, he or she may require certain criteria of the lenders for a particular portfolio. The user can then apply constraints or rules that serve as qualifiers on the model. The rules or constraints selected through the constraint component 230 can then be applied to the analytic and predictive component 220. The constraints or rules can be a set of predefined rules which are stored in the computer system 200. The constraints or rules could also be variable ranges or limits selectable by a user. Typically, even after applying constraints to the analytic and predictive component, there are many possible candidate solutions that result. The optimization component 210 optimizes the solution so that it aligns with the objectives of the user. The optimization component 210 considers the rules and constraints on the model associated with the analytic and predictive component 220 as well as the objectives of the user to yield the best solution for the given parameters.

The result of the optimization by the optimization module 210 includes an overall performance parameter or metric for measuring the objective of the user. In some embodiments of the invention, this overall performance parameter may include a plurality of performance parameters. This overall performance parameter for an optimized solution is communicated to a conversion component 240. The conversion component 240 converts the performance parameter so that it can be visually presented at a display 260. In other words, the conversion component 240 converts outputs from the optimization component 210, analytic and predictive component 220 and the constraint component 230 to a visual output at the display 260. The display 260 may also include a portion that elicits input from the user. Once an input is obtained at the display 260, the display input is converted at the conversion component 240 and input to the optimization component 210, analytic and predictive component 220 and the constraint component 230. In other words, inputs that are elicited and received at the display are converted to inputs for use by the conversion component 240 and input to the optimization component 210, analytic and predictive component 220.

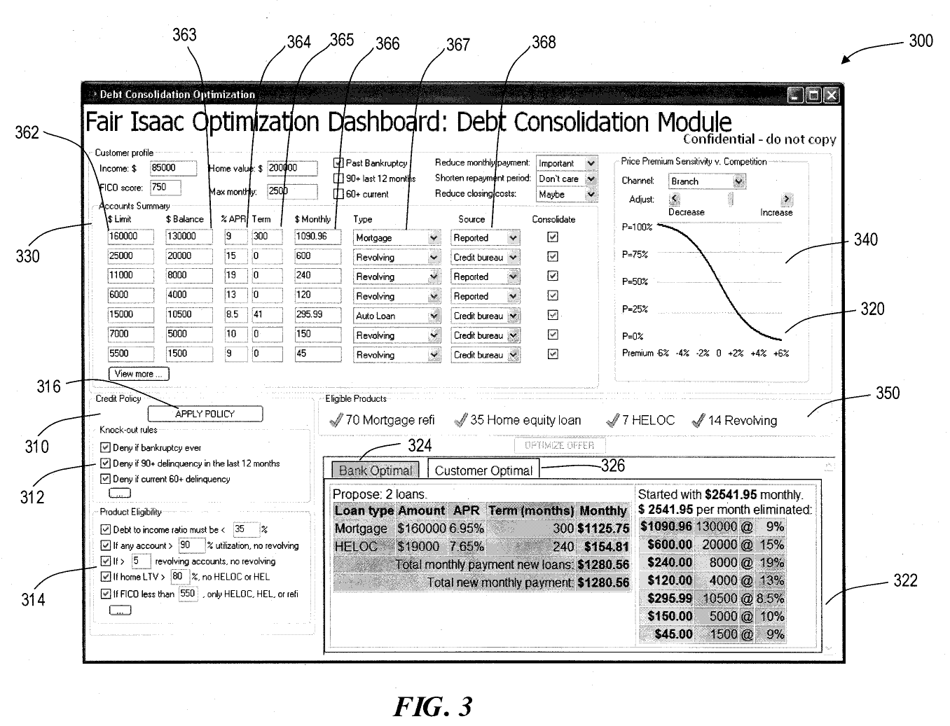

FIG. 3 shows a screen shot 300 from a display, such as display 2022 (shown in FIG. 1) or display 260 (shown in FIG. 2), according to an example embodiment. The screen shot 300 is part of an active display which changes from time to time as various selections are made and various outputs are displayed on the display. The screen shot 300 represents one time that the active display is captured in time. The screen shot has certain components that may be shown on the screen through various screen shots and may remain constant for a selected time including several or a plurality of screen shots. The screen shot associated with the active display of the display device includes a first user interface component 310 and a second user interface component 320. The first user interface component 310 is adapted to elicit and receive information from a user. The first interface component 310 presents a plurality of constraints to a user and prompts the user to select at least one of the plurality of constraints. As mentioned above, the computer system also includes a conversion component 240 (shown in FIG. 2) for converting the at least one of the plurality of constraints which has been selected to an input to the optimization component 230 (shown in FIG. 2). As shown in FIG. 3, the first interface component 310 is a “credit policy” that includes a set of constraints 312 labeled as “knock out rules”. The first interface component also includes a second set of constraints 314 labeled “product eligibility”. The user is prompted to check certain boxes and to fill in selected values. All these are rules or constraints to be applied to the predictive and analytic component 2220, the optimization component 210, the constraint component 230. The various constraints selected are applied to the process by clicking on an apply button 316, such as the button labeled “apply policy” in FIG. 3. It should be noted that the particular screen shot 300 is for a system that is applying a credit policy to a plurality of lenders and that other processes or business decisions relating to other fields could also be optimized. For example, business decisions regarding scheduling of sporting events to maximize revenue, collections on debt, asset/portfolio maximization, capital allocation, product portfolio and pricing, insurance pricing are just some of the possible business areas that may employ a similar computer system.

The screen shot 300 also includes a second user interface component 320 adapted to present performance information to a user. The performance information 320, as presented, includes an output from the optimization component 210 (shown in FIG. 2). The output is based, in part, on the at least one constraint selected by the user through the user interface, such as the first interface component 310 depicted by the screen shot 300. The optimization component 210 optimizes performance based upon the selected constraints applied to the analytic and predictive component 220. After applying the selected constraints, such as by clicking on the “apply policy” button 316, the optimization component 210 determines at least one optimized result and an associated performance parameter that is associated with the at least one optimized result. The second user interface component 320 displays this performance parameter after the performance parameter is converted from an output to an output that can be displayed at the conversion component 240. As shown in FIG. 3, the performance parameter is displayed as a “price premium sensitivity vs. competition” on the screen shot 300. It should be noted that more than one performance parameter may be determined and displayed. As shown in the screen shot 320, another performance parameter 322 may also be displayed. In this case the optimization component 210 also considers the constraints and rules applied and determines an optimized offer 322 which includes and optimal result for the bank 324 and an optimal result for the customer 326.

In still further embodiments, the computer system further includes a third interface component 330 for presenting other data related to the problem to the user. In one embodiment, in the third interface component presents historical data to the user. The historical data can be used to make a business decision related to that historical data. As shown in FIG. 3, the data associated with the third interface component 330 is data related to the customer and is labeled as the “customer profile”.

Of course, the screen shot 300 shown in FIG. 3 is not the only way to display the first interface component 310, the second interface component 320 or the third interface component 330. In one embodiment of the computer system, the first interface component 310 presents a plurality of constraints to a user as a drop down menu of options. In another embodiment, the first interface component 310 presents a plurality of constraints to as a set of limits selectable by the user. The limits can be presented to a user as a range having an upper limit and a lower limit. In still another embodiment, the first interface component presents a plurality of constraints to a user as a plurality of rules. The computer system, in some embodiments, further includes a memory for storing data and has a predictive component. The predictive component predicts future events using at least one model based on the data stored in memory, such as a database. The model is in the form of a problem.

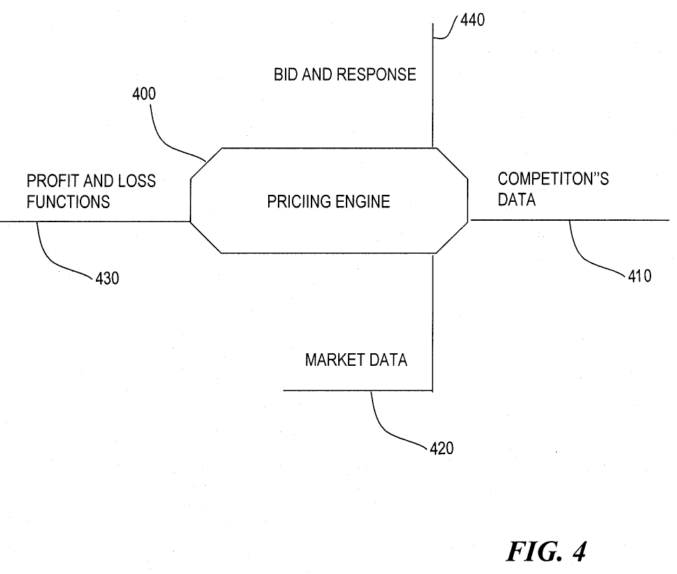

FIG. 4 is a schematic diagram of a pricing engine 400 that is used as part of optimizing the predictive model based on the inputs selected by a user. The pricing engine 400 is used to produce one of the performance parameters 320 set forth on the screen shot 300 of the display. The pricing engine 400 uses inputs such as competitive data 410, market data 420, profit and loss functions 430 and a bid and response function 440 to produce the performance parameter associated with the second interface component 320 which is entitled “price premium sensitivity vs. competition” shown in FIG. 3.

It should be noted that the active display depicted by one screen shot 300 of many screen shots facilitates the user posing one or more “what if” scenarios to the computer system 2000 (shown in FIG. 1) or computer system 200 (shown in FIG. 2). The user can change the constraints or rules, and apply the changes. The optimization engine then determines one or more optimal results and presents them to the user. The user then has the option to change one or more rules or constraints and apply those in an alternate scenario. This can be repeated until the user is satisfied with the result. In some instances, the results may be so far out of line with the objectives of the user so as to let the user no there may be no option with respect to a particular customer. In essence, the user can employ an iterative approach to determine a set of rules to a model from a data base to determine if a set of rules can be put in place that will produce a performance that is desired by the user.

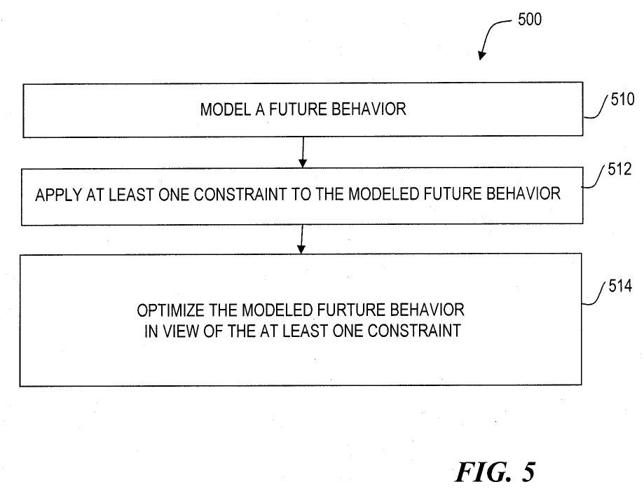

FIG. 5 is a flow diagram of a method 500 associated with the computer system, according to an example embodiment. The method 500 includes modeling a future behavior 510, applying constraints to the modeled future behavior 512, and optimizing the modeled future behavior in view of the constraints 514.

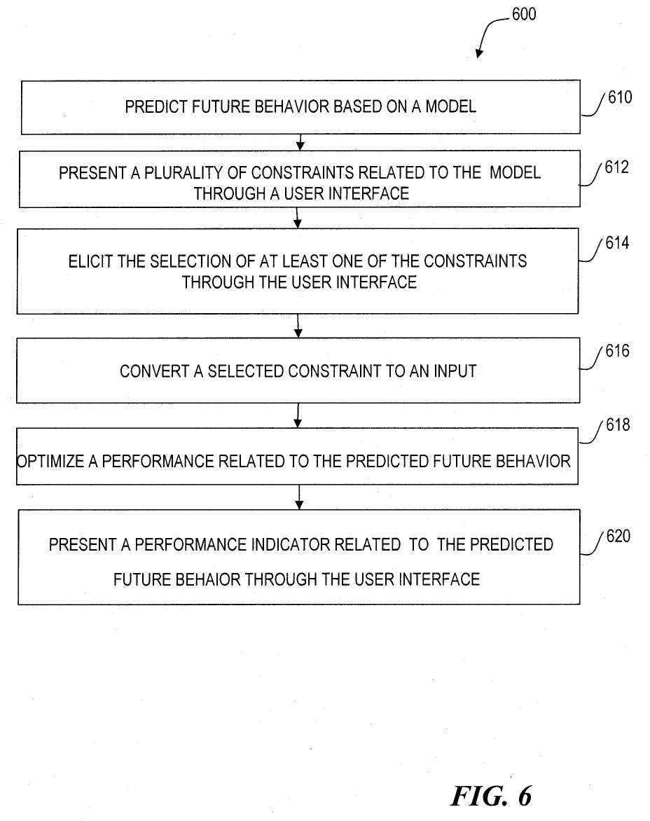

FIG. 6 is a flow diagram of a method associated with the computer system, according to an example embodiment. The method 600 includes predicting future behaviors based on a model 610, and presenting a plurality of constraints related to the model through a user interface 612. The method 600 also includes eliciting the selection of at least one of the plurality of constraints through the user interface 614, and converting a selected constraint to an input 616. The input is related to at least one of the plurality of constraints and is used to optimize a performance related to the predicted future behavior 618. Once optimized, the performance related to the predicted future behavior is presented through the user interface 620. The user interface receives input from the optimization component. Eliciting the selection of at least one of the plurality of constraints includes presenting a pull down menu that includes a plurality of constraints, or presenting a limit related to at least one of a plurality of constraints, or presenting a range of limits related to at least one of the plurality of constraints.

In another embodiment, the method 600 can include presenting selected historical data through the user interface. The historical data, in one embodiment, is related to business transactions. The input related to at least one of the plurality of constraints, in one embodiment, is input to an optimization component. In one embodiment, the plurality of constraints includes at least one business rule. The method, in another embodiment, may also include analyzing data to formulate the model. The model is in a mathematical form.

A machine-readable medium provides instructions that, when executed by a machine, cause the machine to predict future behaviors based on a model, and present a plurality of constraints related to the model through a user interface, and elicit the selection of at least one of the plurality of constraints through the user interface. The selected constraint is converted to an input, which is used to optimize a performance variable related to the predicted future behavior. The performance variable is related to the predicted future behavior through the user interface. The machine-readable medium, in some embodiments, provides instructions that, when executed by a machine, further cause the machine to present a pull down menu that includes a plurality of constraints. In still other embodiments, the instructions cause the machine to analyze data to formulate the model.

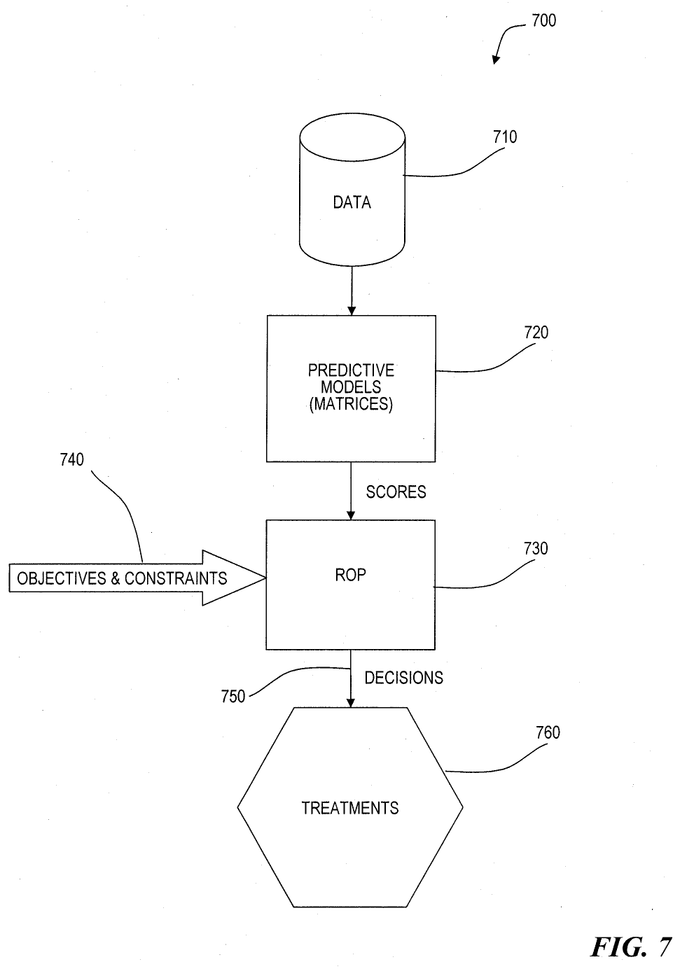

FIG. 7 shows a flow diagram of an optimization of an optimization process 700, according to an example embodiment. A set of data 710, in the form of a multiple dimensioned matrix, is scored or provided with propensities or risk factors for the occurrence of a number of specific events during a desired time. The result is a matrix 720 having cells for each combination of customer and event. In each cell or in many of the cells, there is a risk factor or propensity number reflective of the probability of the event occurring. The scores are input to the optimization component 730. Inputs to the optimization component 730 are objectives and constraints 740. These objectives and constraints 740 can be rules reflective of the basis for the making the business decisions. For example, the objectives and constraints 740 can include which products or product group from which to make recommendations. They could also include a grouping of one or more customers to whom to make recommendations. Still another objective and constraint 740 might be a budget associated with making recommendations. Given the objectives and constraints 740 as well as the scores, a recommendation optimization module 730 optimizes the cells that remain. Decisions 750 can then be made in response to the optimization process. The decisions 750 will be made in response to the cells that remain after the optimization process. The decisions 750 made result in specific treatments 760.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein will be apparent to those of skill in the art upon reviewing the above description.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed:

1. A computer system comprising:
an optimization component for optimizing a solution to a problem using a computer;
a display including a first user interface component adapted to elicit and receive information from a user, the first interface component presenting a plurality of constraints to a user and prompting the user to select at least one of the plurality of constraints; and
a conversion component for converting the at least one of the plurality of constraints which has been selected to an input to the optimization component;
the display further comprising a second user interface component adapted to present performance information to a user, the performance information including an output from the optimization component, the output based in part on the at least one constraint selected by the user.

2. The computer system of claim 1 wherein the first interface component presents a plurality of constraints to a user as a drop down menu of options.

3. The computer system of claim 1 wherein the first interface component presents a plurality of constraints to as a set of limits selectable by the user.

4. The computer system of claim 1 wherein the first interface component presents a plurality of constraints to a user as a range having an upper limit and a lower limit.

5. The computer system of claim 1 wherein the first interface component presents a plurality of constraints to a user as a plurality of rules.

6. The computer system of claim 1 further comprising:
a memory for storing data;
a predictive component which predicts future events using at least one model based on the data stored in memory, wherein the model is in the form of a problem, and wherein the optimization component optimizes performance based upon the selected constraints applied to the predictive component.

7. The computer system of claim 1 further comprising a third interface component for presenting data related to the problem to the user.

8. The computer system of claim 7 wherein the third interface component presents historical data to the user.

9. A method comprising:
predicting future behaviors based on a model;
presenting a plurality of constraints related to the model through a user interface;
eliciting the selection of at least one of the plurality of constraints through the user interface;
converting a selected constraint to an input; and
using the input related to at least one of the plurality of constraints to optimize a performance related to the predicted future behavior; and
presenting the performance related to the predicted future behavior through the user interface.

10. The method of claim 9 wherein eliciting the selection of at least one of the plurality of constraints includes presenting a pull down menu that includes a plurality of constraints.

11. The method of claim 9 wherein eliciting the selection of at least one of the plurality of constraints includes presenting a limit related to at least one of a plurality of constraints.

12. The method of claim 9 wherein eliciting the selection of at least one of the plurality of constraints includes presenting a range of limits related to at least one of the plurality of constraints.

13. The method of claim 9 further comprising presenting selected historical data through the user interface.

14. The method of claim 13 wherein the historical data is related to business transactions.

15. The method of claim 9 wherein the input related to at least one of the plurality of constraints is input to an optimization component.

16. The method of claim 9 wherein the plurality of constraints includes at least one business rule.

17. The method of claim 9 further comprising an analyzing data to formulate the model.

18. The method of claim 17 wherein the model is in a mathematical form.

19. A machine-readable medium that provides instructions that, when executed by a machine, cause the machine to:
predict future behaviors based on a model;
present a plurality of constraints related to the model through a user interface;
elicit the selection of at least one of the plurality of constraints through the user interface;
convert a selected constraint to an input;
use the input related to at least one of the plurality of constraints to optimize a performance related to the predicted future behavior; and
present the performance related to the predicted future behavior through the user interface.

20. The machine-readable medium of claim 19 that provides instructions that, when executed by a machine, further cause the machine to present a pull down menu that includes a plurality of constraints.

21. The machine-readable medium of claim 19 that provides instructions that, when executed by a machine, further cause the machine to analyze data to formulate the model.

22. A method comprising:
modeling a future behavior;
applying constraints to the modeled future behavior;
optimizing the modeled future behavior in view of the constraints.
